(19) United States
(12) Patent Application Publication
(10) Pub. No.: US 2002/0138586 A1
(43) Pub. Date: Sep. 26, 2002

(54) Reducing network congestion by decoupling attachments from electronic mail

(75) Inventors: Ilan Paleiov, Kfar Vradim (IL); Amnon Ribak, Yuvalim (IL)

Correspondence Address: DARBY & DARBY P.C., 805 Third Avenue, New York, NY, 10022, US

(73) Assignee: International Business Machines Corporation

(21) Appl. No.: 09/814,901

(22) Filed: Mar. 22, 2001

(51) Int. Cl. G06F 15/16

(52) U.S. Cl. 709/207; 709/206

(57) ABSTRACT

A method for processing an electronic mail (e-mail) message having an attachment is provided. The method includes receiving as input from a sender the e-mail message and the attachment, for transmission across a network to a recipient. Respective first and second priorities are assigned for transmission of the message and the attachment. The message is sent to the recipient at the first priority, and the attachment is sent to the recipient at the second priority.

### FIELD OF THE INVENTION

The present invention relates generally to electronic mail, and specifically to methods and apparatus for processing electronic mail.

### BACKGROUND OF THE INVENTION

The exchange of messages between two or more users employing electronic mail (e-mail) is widely known. A piece of e-mail typically includes a short message or piece of text. In addition, larger files called “attachments” are often attached to the e-mail. The attachments may include, for example, graphic files, audio or video files, word processing or other data files.

Frequently, a user sends a copy of an e-mail with an attachment both to one or more primary recipients and to a set of carbon copy recipients. Using existing technology, the e-mail and the attachment are sent generally simultaneously to each recipient, often placing a significant load on network resources. Thus, for example, a 3 kB e-mail message describing the sender's vacation may be attached to a 6 MB file containing a set of color photographs, and then sent to 40 recipients. The Internet (or other network carrying the e-mail) is then required to arrange the rapid transfer of 120 kB of text and 240 MB of attachments. This simple example describes how e-mail attachments may congest a network and take up significant disk space.

U.S. Pat. No. 5,948,058 to Kudoh et al., which is incorporated herein by reference by reference, describes a method for cataloging and displaying e-mail.

U.S. Pat. No. 5,544,360 to Lewak et al., which is incorporated herein by reference, describes a method for accessing computer files and data.

U.S. Pat. No. 5,771,355 and 5,781,901 to Kuzma, and U.S. Pat. No. 5,613,108 to Morikawa, which are incorporated herein by reference, describe various methods for processing e-mail, typically to minimize costs.

U.S. Pat. No. 5,903,723 to Beck et al., which is incorporated herein by reference, describes a method for transmitting electronic mail attachments with attachment references. An attachment reference is generated, which includes a network address where the attachment is stored. The attachment reference is transmitted from the sender to a recipient, and the recipient is enabled to access the attachment at the network address.

The prior art does not provide a full solution to the congestion of pathways of a communication network when e-mails with heavy attachments are sent to a multiplicity of recipients. Lotus Notes (Lotus Notes 4.5 Standard Mail Template Version 7, from Lotus, Cambridge, Mass.) gives a user the option of either sending or not sending attachments in replied and forwarded mail. U.S. Pat. No. 5,903,723 partially addresses the problem by sending the e-mail with an attachment reference, but without the attachment itself. Nevertheless, when a significant number of the recipients access the attachment, a large amount of network communications bandwidth will still be consumed.

Some programs (e.g., “Scan Mail for Open Mail,” Trend Micro Inc., Cupertino, Calif.) filter received e-mail and prevent virus-infected e-mail attachments from being transferred to their designated recipients.

### SUMMARY OF THE INVENTION

It is an object of some aspects of the present invention to provide improved apparatus and methods for processing electronic mail.

In preferred embodiments of the present invention, a piece of electronic mail including a message and an attachment to the message is processed by an e-mail server that is assigned to transmit the piece of e-mail over an electronic network to a recipient. Preferably, the server separates the message from the attachment, and sends the message and the attachment across the network over separate channels. Further preferably, the e-mail message is sent over the first channel at a relatively high priority, and the attachment is sent over the second channel at a relatively low priority. These embodiments typically reduce network congestion by efficiently redistributing overall network loading, and by reducing the demands of high traffic that are intermittently placed on particular nodes in the network.

E-mail processed in accordance with these embodiments of the present invention often arrives and is completely re-assembled at the recipient's mail server prior to the recipient logging in and downloading her e-mail. At other times, the e-mail is received by the recipient in stages. The e-mail message is typically received first, preferably with an indication that transmission of the attachment has not been completed. The recipient is, however, enabled to read the message substantially earlier than would be possible using prior art techniques, in which the message and all attachments thereto must typically be received in their entirety by the recipient's local mail server, prior to the recipient being allowed to download the e-mail. Subsequently—typically within several minutes or hours—the attachment is received, and it is preferably seamlessly re-coupled to the e-mail message. If the recipient has already read the message, then she is preferably advised that the attachment has arrived.

In some preferred embodiments, if the recipient deletes the e-mail message prior to receiving the attachment, and if at that point the attachment is at an intermediate server on the network whose network ID is known or can be ascertained by the recipient's mail server, then the recipient's server preferably transmits to the intermediate server a command that the intermediate server should delete the attachment. Alternatively, the recipient may indicate that she wants immediate delivery of the attachment, in which case a command is transmitted to the intermediate server instructing it to give maximum priority to sending the attachment to the recipient.

Alternatively, if the recipient deletes the e-mail message prior to receiving the attachment, then the recipient's mail server or the recipient's own computer preferably automatically deletes the attachment when it arrives, typically without informing the recipient. Alternatively or additionally, the recipient is enabled to keep the e-mail but to “delete” the attachment prior to receiving it, preferably preventing thereby the later downloading of the attachment to her computer, and, if feasible at that point, preventing further transmission of the attachment through the network.

Preferably, methods known in the art for dividing data into packets, transmitting the packets, and re-assembling the original data are applied, mutatis mutandis, to assure that an e-mail message and its one or more attachments are properly re-coupled following transmission over the different channels utilized by these embodiments of the present invention. For example, Globally Unique ID (GUID) generators in common use today may be adapted to assign identical or paired GUID's for the message and its attachments, so as to enable their seamless re-assembly. It is noted in addition that the simple mail transfer protocol (SMTP), which is currently used in the processing of e-mail, distinguishes between an e-mail message and the files attached thereto, and can be adapted by one of ordinary skill in the art having read the disclosure of the present patent application to assign different priorities or other characteristics to the message and its attachments.

For some applications, the sender is enabled to designate which of a number of recipients should receive the e-mail message together with the attachment, and which of the recipients should receive the message without the attachment. Preferably, the e-mail is sent over the network in accordance with the sender's designation, without requiring the sender to manually prepare separate e-mails for the different groups of recipients. In combination with the use of separate channels for sending the e-mail and the attachment, this method of processing e-mail even further reduces the loading of the network, by reducing the total number of copies of attachments which are sent to the recipients.

It is noted that in addition to saving resources of the network, these embodiments of the present invention additionally reduce recipients' downloading time and conserve hard disk space on computers of recipients who choose not to receive an attachment, or who are designated by the sender not to receive the attachment. (Very few e-mail recipients, it is believed, make a practice of going through their received e-mail and deleting unwanted attachments to e-mail messages.)

In some instances, the loading on the network may be reduced, alternatively or additionally, by sending a single copy of a piece of e-mail to a destination server, and instructing the destination server to distribute copies of the e-mail to a list of recipients local to the destination server. Typically, the destination server handles the e-mail of the employees of a particular company, or of members in an organization. In this manner, multiple copies of the piece of e-mail are only transmitted across a relatively small portion of the network—that part connecting the destination server to each of the recipients. This is an improvement over the prior art, wherein the sender (or the sender's server) typically sends all of the copies of an e-mail across the entire network.

There is therefore provided, in accordance with a preferred embodiment of the present invention, a method for processing an electronic mail (e-mail) message having an attachment, including:

receiving as input from a sender the e-mail message and the attachment, for transmission across a network to a recipient;

assigning respective first and second priorities for transmission of the message and the attachment;

sending the message to the recipient at the first priority; and

sending the attachment to the recipient at the second priority.

Preferably, assigning the priorities includes setting the first priority to be higher than the second priority.

Alternatively or additionally, assigning the priorities includes receiving a designation of at least one of the priorities from the sender.

In a preferred embodiment, sending the attachment includes:

routing the attachment to the recipient by way of an intermediate server; and

directing the intermediate server to wait for a command from the recipient, and to delete the attachment responsive to receiving a delete command from the recipient.

Alternatively or additionally, sending the attachment includes:

routing the attachment to the recipient by way of an intermediate server; and

directing the intermediate server to wait for a command from the recipient, and to send the attachment to the recipient only after receiving the command.

For example, directing the intermediate server to send the attachment to the recipient may include directing the intermediate server to change the second priority prior to sending the attachment.

Sending the attachment typically includes:

routing the attachment to the recipient by way of an intermediate server; and

directing the intermediate server to send the attachment to the recipient at low priority.

For some applications, directing the intermediate server to send the attachment to the recipient at low priority includes directing the intermediate server to store the attachment until a level of traffic on the network is below a threshold level.

In a preferred embodiment, the method includes:

receiving a command; and

interrupting transmission of the attachment, responsive to the command, so as to prevent receipt of the attachment by the recipient.

For example, receiving the command may include receiving the command from the recipient.

Typically, the method includes coupling respective identifiers to the message and the attachment, prior to sending the message and attachment, so as to enable a mail server receiving the message and attachment to identify a correspondence between the message and the attachment. For example, coupling the identifiers may include coupling respective Globally Unique ID's (GUID's) to the message and the attachment.

There is further provided, in accordance with a preferred embodiment of the present invention, a method for processing electronic mail (e-mail), including:

receiving, at an intermediate server, from a sending server, an attachment of an e-mail message, the message and the attachment having different respective transmission priorities;

storing the attachment;

receiving a command from a designated recipient of the attachment; and

processing the attachment responsive to the command.

In a preferred embodiment, receiving the command includes receiving the command subsequent to a deletion of the message by the recipient.

For some applications, processing the attachment includes deleting the attachment. Alternatively or additionally, processing the attachment includes sending the attachment to the recipient. Further alternatively or additionally, processing the attachment includes changing the transmission priority of the attachment.

There is still further provided, in accordance with a preferred embodiment of the present invention, a method for processing electronic mail (e-mail), including:

receiving over an electronic network an e-mail message having a first transmission priority;

subsequent to receiving the e-mail message, receiving over the electronic network an attachment to the e-mail message, the attachment having a second transmission priority;

identifying a correspondence between the e-mail message and the attachment; and

downloading the e-mail message with the attachment to a designated recipient.

There is yet further provided, in accordance with a preferred embodiment of the present invention, a method for processing electronic mail (e-mail), including:

receiving over an electronic network an e-mail message sent with a first transmission priority;

receiving with the e-mail message an identifier of an attachment to the e-mail message, the attachment having a second transmission priority;

downloading the e-mail message to a designated recipient thereof;

transmitting the identifier to the recipient; and

receiving from the recipient a command with respect to the attachment.

Typically, receiving the command includes receiving a command to delete the attachment or receiving a command to change the transmission priority of the attachment.

There is also provided, in accordance with a preferred embodiment of the-present invention, a method for processing a piece of electronic mail (e-mail), including:

receiving the e-mail as input from a sender;

analyzing addresses of a list of recipients of the e-mail, so as to determine two or more of the recipients who are served by a common e-mail server;

sending a single copy of the e-mail to the e-mail server; and

sending a command to the e-mail server directing the server to distribute the e-mail to the two or more recipients.

There is additionally provided, in accordance with a preferred embodiment of the present invention, apparatus for processing an electronic mail (e-mail) message having an attachment, the apparatus including a server, the server including:

a data port; and

a processor, arranged to assign to the e-mail message and the attachment respective first and second transmission priorities, to actuate the data port to send the message over an electronic network to a recipient at the first priority, and to actuate the data port to send the attachment over the network to the recipient at the second priority.

There is still additionally provided, in accordance with a preferred embodiment of the present invention, apparatus for processing electronic mail (e-mail), the apparatus including a computer server, the computer server including:

a data port arranged to be coupled to an electronic network;

a memory; and

a processor, arranged to: (a) actuate the data port to receive from a sending server an attachment of an e-mail message, the message and the attachment having different respective transmission priorities, (b) actuate the memory to store the attachment, (c) actuate the data port to receive a command from a designated recipient of the attachment, and (d) process the attachment responsive to the command.

There is yet additionally provided, in accordance with a preferred embodiment of the present invention, apparatus for processing electronic mail (e-mail), the apparatus including a mail server, the mail server including:

a data port arranged to be coupled to an electronic network; and

a processor, arranged to: (a) actuate the data port to receive an e-mail message having a first transmission priority, (b) subsequent to receiving the e-mail message, actuate the data port to receive an attachment to the e-mail message, the attachment having a second transmission priority, (c) identify a correspondence between the e-mail message and the attachment, and (d) download the e-mail message with the attachment to a designated recipient.

There is also provided, in accordance with a preferred embodiment of the present invention, apparatus for processing electronic mail (e-mail), the apparatus including a mail server, the mail server including:

a data port arranged to be coupled to an electronic network; and

a processor, arranged to: (a) actuate the data port to receive an e-mail message sent with a first transmission priority, and to receive with the e-mail message an identifier of an attachment to the e-mail message, the attachment having a second transmission priority, (b) download the e-mail message to a designated recipient thereof, (c) transmit the identifier to the recipient, and (d) receive from the recipient a command with respect to the attachment.

There is further provided, in accordance with a preferred embodiment of the present invention, apparatus for processing a piece of electronic mail (e-mail), the apparatus including a server, the server including:

a data port arranged to be coupled to an electronic network; and

a processor, arranged to: (a) analyze addresses of a list of recipients of the e-mail, so as to determine two or more of the recipients who are served by a common e-mail server, (b) actuate the data port to send a single copy of the e-mail to the e-mail server, and (c) actuate the data port to send a command to the e-mail server directing the server to distribute the e-mail to the two or more recipients.

There is still further provided, in accordance with a preferred embodiment of the present invention, a computer program product for processing an electronic mail (e-mail) message having an attachment, the product including a computer-readable medium having program instructions embodied therein, which instructions, when read by a computer, cause the computer to:

receive as input from a sender the e-mail message and the attachment, for transmission across a network to a recipient;

assign respective first and second priorities for transmission of the message and the attachment;

send the message to the recipient at the first priority; and

send the attachment to the recipient at the second priority.

There is yet further provided, in accordance with a preferred embodiment of the present invention, a computer program product for processing electronic mail (e-mail), the product including a computer-readable medium having program instructions embodied therein, which instructions, when read by a computer, cause the computer to:

receive, at an intermediate server, from a sending server, an attachment of an e-mail message, the message and the attachment having different respective transmission priorities;

store the attachment;

receive a command from a designated recipient of the attachment; and

process the attachment responsive to the command.

There is also provided, in accordance with a preferred embodiment of the present invention, a computer program product for processing electronic mail (e-mail), the product including a computer-readable medium having program instructions embodied therein, which instructions, when read by a computer, cause the computer to:

receive over an electronic network an e-mail message having a first transmission priority;

subsequent to receiving the e-mail message, receive over the electronic network an attachment to the e-mail message, the attachment having a second transmission priority;

identify a correspondence between the e-mail message and the attachment; and

download the e-mail message with the attachment to a designated recipient.

There is additionally provided, in accordance with a preferred embodiment of the present invention, a computer program product for processing electronic mail (e-mail), the product including a computer-readable medium having program instructions embodied therein, which instructions, when read by a computer, cause the computer to:

receive over an electronic network an e-mail message sent with a first transmission priority;

receive with the e-mail message an identifier of an attachment to the e-mail message, the attachment having a second transmission priority;

download the e-mail message to a designated recipient thereof;

transmit the identifier to the recipient; and

receive from the recipient a command with respect to the attachment.

There is still additionally provided, in accordance with a preferred embodiment of the present invention, a computer program product for processing a piece of electronic mail (e-mail), the product including a computer-readable medium having program instructions embodied therein, which instructions, when read by a computer, cause the computer to:

receive the e-mail;

analyze addresses of a list of recipients of the e-mail, so as to determine two or more of the recipients who are served by a common e-mail server;

send a single copy of the e-mail to the e-mail server; and

send an instruction to the e-mail server directing the server to distribute the e-mail to the two or more recipients.

The present invention will be more fully understood from the following detailed description of the preferred embodiments thereof, taken together with the drawings, in which:

### BRIEF DESCRIPTION OF THE DRAWINGS

FIG. 1 is a simplified pictorial illustration showing a system for processing e-mail, in accordance with a preferred embodiment of the present invention; and

FIG. 2 is a flow chart showing a method for processing e-mail, in accordance with a preferred embodiment of the present invention.

### DETAILED DESCRIPTION OF PREFERRED EMBODIMENTS

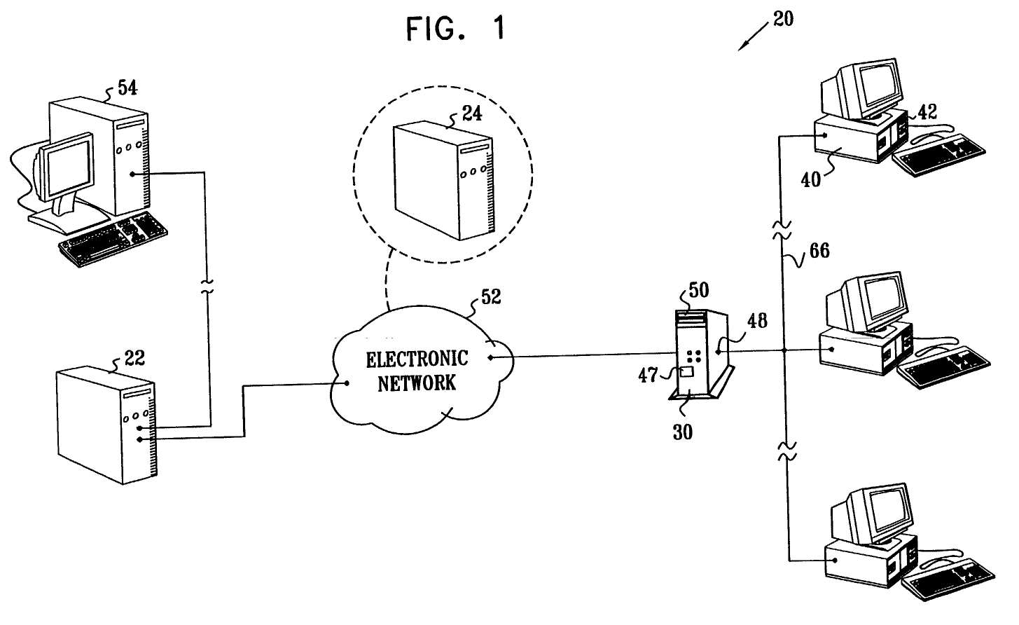

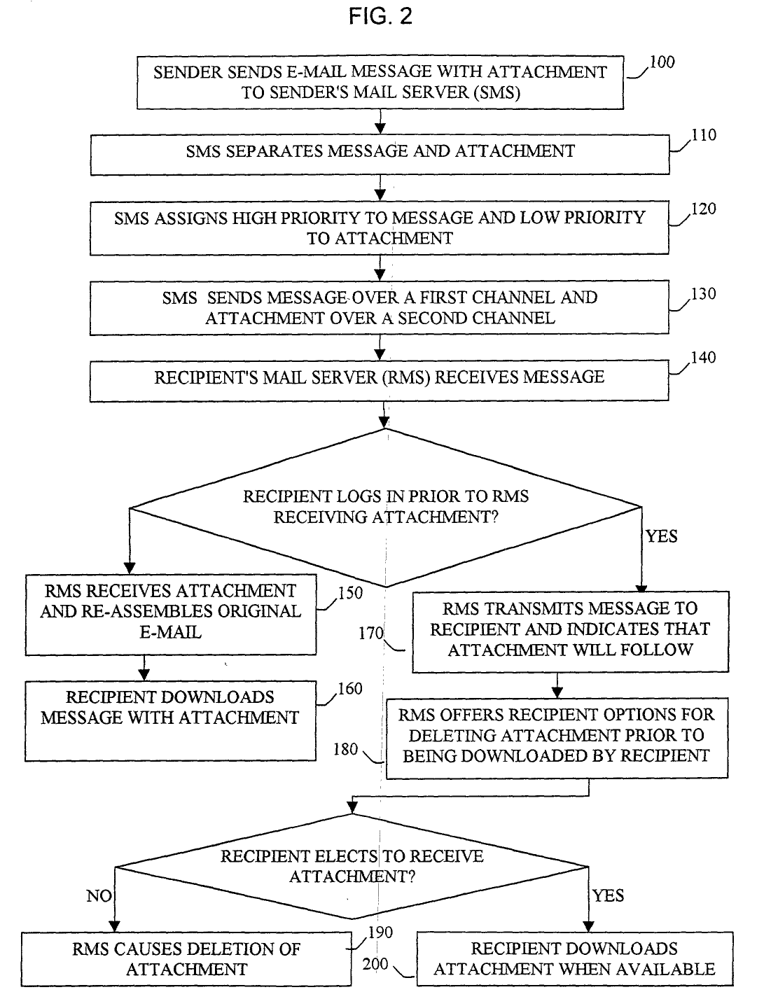

Reference is now made to FIGS. 1 and 2. FIG. 1 is a simplified pictorial illustration showing a system 20 for processing e-mail, in accordance with a preferred embodiment of the present invention. FIG. 2 is a flow chart, illustrating a method utilized by system 20 to process e-mail, in accordance with a preferred embodiment of the present invention. System 20 is typically utilized to reduce congestion and inefficient resource allocation in an electronic, network 52. Additionally, system 20 commonly significantly increases the speed with which e-mail messages are delivered to recipients. The various components of system 20 are preferably constructed generally in accordance with standards known in the art, comprising hardware such as a processor 47, a data port 48, and a memory 50, which are configured to allow the processing of electronic mail.

In a typical use of system 20, a sender composes an e-mail message on a computer 54 and attaches a file thereto. In a sending step 100, the sender sends the message and the attachment to a mail server 22 local to the sender, such as the sender's Internet Service Provider (ISP). Server 22 separates the message and the attachment in a separation step 110, and typically, although not necessarily, assigns a high transmission priority to the message and a low transmission priority to the attachment in an assignment step 120.

In a server sending step 130, server 22 preferably sends the message to a designated recipient over a first channel of network 52, and sends the attachment to the recipient over a second channel of the network. Reference to first and second “channels” in the present patent application and in the claims is to be understood as being distinguished from prior art e-mail transmission techniques, in which mail servers transmit e-mail messages and attachments without deliberately dividing them into two separate units for transmission, such that, for example, the message would be able to be downloaded by a recipient prior to complete transmission of the attachment.

Although one of ordinary skill in the art, having read the disclosure of the present patent application, would be able to determine a number of ways to divide a piece of e-mail into a message component and an attachment component, and send these components substantially independently through a network, a preferred embodiment of the present invention includes the modification of an e-mail protocol, as described hereinbelow. The Multipurpose Internet Mail Extensions (MIME) standard is in common use today to facilitate the transfer of e-mail messages with attachments. In accordance with a preferred embodiment of the present invention, a new MIME type, “Content-transfer: detached” is defined, and indicates to servers processing the piece of e-mail that: (a) the attachment has been detached from the message, (b) the attachment is to be routed to the recipient independent of the routing of the message, and (c) the attachment is ultimately to be re-attached to the message when both have been received by a mail server 30 of the recipient (e.g., her ISP), unless instructions to the contrary have been issued. Preferably, a Globally Unique ID (GUID) or other identifier is incorporated into both the message and the attachment in step 110, so as to allow unambiguous re-assembly of the components of the original piece of e-mail after transmission through electronic network 52.

In general, mail server 30 receives the message, in a message receipt step 140, prior to receiving the attachment. This occurs because the message is usually significantly smaller than the attachment, and also because the message is usually transmitted at a higher priority than the attachment. Thus, for example, if data traffic on network 52 is very high, message receipt step 140 may have already have been performed while the attachment is still being stored on server 22 or on an intermediate server 24 coupled to network 52. In some cases, transmission of the attachment may only be executed late at night, when data traffic is typically at a minimum, or when traffic is below a threshold level.

In a preferred embodiment, a plurality of intermediate servers 24 are distributed at various locations on the network, and are dedicated at least in part to the temporary storage of attachments from one or more mail servers. Alternatively or additionally, this functionality is incorporated directly into mail servers such as mail server 22. Typically, intermediate servers 24 “absorb” the large attachments that would otherwise interfere with the movement of high priority data, and these servers later release the attachments back to the network when traffic is lower. In this manner, substantial savings are typically achieved, because less hardware is needed to support the peak data exchange rates currently experienced by networks such as the Internet.

In a common scenario, the designated recipient of the piece of e-mail only logs in to mail server 30 relatively infrequently (e.g., daily) to receive her e-mail. Thus, server 30 generally has already received the attachment and re-assembled it with the message in a re-assembly step 150. In a downloading step 160, the recipient preferably downloads the re-assembled piece of e-mail from server 30, in accordance with standard procedures for receiving electronic mail.

Often, however, the recipient logs in to mail server 30 after step 140, but prior to receipt by server 30 of the attachment. In this case, server 30 preferably transmits the message to the recipient in a transmission step 170, and additionally inserts in a header of the message the words, “This message was sent with an attachment which has not yet been received. Try again later.” Optionally, the recipient is enabled at this point to raise the transmission priority of the attachment, so as to decrease the time until it is received at server 30. For some applications, the attachment is deliberately stored on server 22 or intermediate server 24, and is only transmitted through electronic network 52 to mail server 30 if the recipient indicates that she does want to receive the attachment.

In a preferred embodiment, mail server 30 offers the recipient, in an options step 180, the option of deleting the attachment prior to its being downloaded by the recipient. If the recipient declines, then the attachment is preferably downloaded in a download step 200 once it has been received by server 30. If the recipient chooses to delete the attachment, however, then the recipient's instruction preferably causes server 30 in a deletion step 190 to send a command to mail server 22 or intermediate server 24, directing that the attachment be deleted without being forwarded to server 30. Alternatively, server 30 waits until it receives the attachment, and then performs the deletion in response to the recipient's instruction.

Alternatively or additionally, a processor 42 of a computer 40 operated by the recipient sends a “delete attachment” instruction to server 30 if, prior to receiving the attachment, the recipient deletes the message from computer 40. Preferably, an option is provided for the recipient to specify that, although she deleted the message from computer 40, she nevertheless wants to receive the attachment.

For some applications, server 22 directs that a piece of e-mail that is addressed to a plurality of recipients served by a single server 30 be sent only once to server 30, accompanied by instructions for server 30 to distribute the e-mail to each of the recipients, typically across a network 66 which is local to both server 30 and the recipients. Preferably, but not necessarily, the piece of e-mail includes one or more attachments, which are separated from the e-mail message and processed generally in accordance with the techniques shown in FIG. 2. Further preferably, server 22 is configured to scan the e-mail addresses of a list of recipients in the header of the e-mail, in order to determine those who are served by one server, e.g., those having addresses ending in “. . . @particular-company-name.com.” It will be appreciated that if the e-mail is large and if the distribution list at the company is similarly large, then the delivery time of the e-mail to all of the recipients will be substantially reduced using this technique, because the total number of bytes (determined by the product of the size of the e-mail and the number of recipients) only needs to be transmitted through the very last link in the chain of delivery of the e-mail. By contrast, using prior art techniques, many portions of the Internet would experience much higher data traffic in transmitting multiple copies of the sender's e-mail.

Alternatively or additionally, the sender prepares a piece of e-mail including a message and an attachment, and addresses the e-mail to a list of recipients. In addition, the sender designates to server 22 which of the recipients should receive the e-mail message together with the attachment, and which of the recipients should receive the message without the attachment. If the message has a plurality of attachments, then the sender is preferably enabled to designate which recipients should receive which ones of the attachments. Server 22, in turn, prepares and sends the e-mail over network 52 in accordance with the sender's designation, without requiring the sender to manually prepare separate e-mails for the different groups of recipients. This method for processing e-mail typically significantly reduces the loading on network 52, by reducing the total number of copies of attachments which are sent to the recipients. By contrast, prior art e-mail systems typically send an e-mail and its attachment to all of the listed recipients, without providing an option for specifying those recipients who should not receive the attachment. Thus, using any of the most popular e-mail programs available today, a user who wants to send a 10 kB e-mail with a 5 MB attachment to 40 recipients will ultimately cause the transfer of 400 kB of e-mail and 200 MB of attachments. These prior art programs do not enable the sender to specify that, for example, three technicians in the list of recipients should receive the attachment with the e-mail message, and the remaining personnel should receive only the message.

It will be understood by one skilled in the art that aspects of the present invention described hereinabove can be embodied in a computer running software, and that the software can be supplied and stored in tangible media, e.g., hard disks, floppy disks or compact disks, or in intangible media, e.g., in an electronic memory, or on a network such as the Internet.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for processing an electronic mail (e-mail) message having an attachment, comprising:
receiving as input from a sender the e-mail message and the attachment, for transmission across a network to a recipient;
assigning respective first and second priorities for transmission of the message and the attachment;
sending the message to the recipient at the first priority; and
sending the attachment to the recipient at the second priority.

2. A method according to claim 1, wherein assigning the priorities comprises setting the first priority to be higher than the second priority.

3. A method according to claim 1, wherein assigning the priorities comprises receiving a designation of at least one of the priorities from the sender.

4. A method according to claim 1, wherein sending the attachment comprises:
routing the attachment to the recipient by way of an intermediate server; and
directing the intermediate server to wait for a command from the recipient, and to delete the attachment responsive to receiving a delete command from the recipient.

5. A method according to claim 1, wherein sending the attachment comprises:
routing the attachment to the recipient by way of an intermediate server; and
directing the intermediate server to wait for a command from the recipient, and to send the attachment to the recipient only after receiving the command.

6. A method according to claim 5, wherein directing the intermediate server to send the attachment to the recipient comprises directing the intermediate server to change the second priority prior to sending the attachment.

7. A method according to claim 1, wherein sending the attachment comprises:
routing the attachment to the recipient by way of an intermediate server; and
directing the intermediate server to send the attachment to the recipient at low priority.

8. A method according to claim 7, wherein directing the intermediate server to send the attachment to the recipient at low priority comprises directing the intermediate server to store the attachment until a level of traffic on the network is below a threshold level.

9. A method according to claim 1, and comprising:
receiving a command; and
interrupting transmission of the attachment, responsive to the command, so as to prevent receipt of the attachment by the recipient.

10. A method according to claim 9, wherein receiving the command comprises receiving the command from the recipient.

11. A method according to claim 1, and comprising coupling respective identifiers to the message and the attachment, prior to sending the message and attachment, so as to enable a mail server receiving the message and attachment to identify a correspondence between the message and the attachment.

12. A method according to claim 11, wherein coupling the identifiers comprises coupling respective Globally Unique ID's (GUID's) to the message and the attachment.

13. A method for processing electronic mail (e-mail), comprising:
receiving, at an intermediate server, from a sending server, an attachment of an e-mail message, the message and the attachment having different respective transmission priorities;
storing the attachment;
receiving a command from a designated recipient of the attachment; and
processing the attachment responsive to the command.

14. A method according to claim 13, wherein receiving the command comprises receiving the command subsequent to a deletion of the message by the recipient.

15. A method according to claim 13, wherein processing the attachment comprises deleting the attachment.

16. A method according to claim 13, wherein processing the attachment comprises sending the attachment to the recipient.

17. A method according to claim 13, wherein processing the attachment comprises changing the transmission priority of the attachment.

18. A method for processing electronic mail (e-mail), comprising:
receiving over an electronic network an e-mail message having a first transmission priority;
subsequent to receiving the e-mail message, receiving over the electronic network an attachment to the e-mail message, the attachment having a second transmission priority;
identifying a correspondence between the e-mail message and the attachment; and
downloading the e-mail message with the attachment to a designated recipient.

19. A method for processing electronic mail (e-mail), comprising:
receiving over an electronic network an e-mail message sent with a first transmission priority;
receiving with the e-mail message an identifier of an attachment to the e-mail message, the attachment having a second transmission priority;
downloading the e-mail message to a designated recipient thereof;
transmitting the identifier to the recipient; and
receiving from the recipient a command with respect to the attachment.

20. A method according to claim 19, wherein receiving the command comprises receiving a command to delete the attachment.

21. A method according to claim 19, wherein receiving the command comprises receiving a command to change the transmission priority of the attachment.

22. A method for processing a piece of electronic mail (e-mail), comprising:
receiving the e-mail as input from a sender;
analyzing addresses of a list of recipients of the e-mail, so as to determine two or more of the recipients who are served by a common e-mail server;
sending a single copy of the e-mail to the e-mail server; and
sending a command to the e-mail server directing the server to distribute the e-mail to the two or more recipients.

23. Apparatus for processing an electronic mail (e-mail) message having an attachment, the apparatus comprising a server, the server comprising:
a data port; and
a processor, arranged to assign to the e-mail message and the attachment respective first and second transmission priorities, to actuate the data port to send the message over an electronic network to a recipient at the first priority, and to actuate the data port to send the attachment over the network to the recipient at the second priority.

24. Apparatus according to claim 23, wherein the processor is arranged to set the first priority to be higher than the second priority.

25. Apparatus according to claim 23, wherein the processor is arranged to receive from a sender a designation of at least one of the priorities.

26. Apparatus according to claim 23, wherein the processor is arranged to actuate the data port to route the attachment to the recipient by way of an intermediate server coupled to the network, and
wherein the processor is arranged to direct the intermediate server to: (a) wait for a command from the recipient, and (b) delete the attachment responsive to receiving a delete command from the recipient.

27. Apparatus according to claim 23, wherein the processor is arranged to actuate the data port to route the attachment to the recipient by way of an intermediate server coupled to the network, and
wherein the processor is arranged to direct the intermediate server to: (a) wait for a command from the recipient, and (b) send the attachment to the recipient only after receiving the command.

28. Apparatus according to claim 23, wherein the processor is arranged to actuate the data port to route the attachment to the recipient by way of an intermediate server coupled to the network, and wherein the processor is arranged to direct the intermediate server to send the attachment to the recipient at low priority.

29. Apparatus according to claim 23, wherein the processor is arranged to receive a command and to interrupt transmission of the attachment, responsive to the command, so as to prevent receipt of the attachment by the recipient.

30. Apparatus according to claim 23, wherein the processor is arranged to couple respective identifiers to the message and the attachment, prior to actuating the data port to send the message and attachment, so as to enable a mail server receiving the message and attachment to identify a correspondence between the message and the attachment.

31. Apparatus for processing electronic mail (e-mail), the apparatus comprising a computer server, the computer server comprising:
a data port arranged to be coupled to an electronic network;
a memory; and
a processor, arranged to: (a) actuate the data port to receive from a sending server an attachment of an e-mail message, the message and the attachment having different respective transmission priorities, (b) actuate the memory to store the attachment, (c) actuate the data port to receive a command from a designated recipient of the attachment, and (d) process the attachment responsive to the command.

32. Apparatus according to claim 31, wherein the processor is arranged to actuate the data port to receive the command at a time subsequent to a deletion by the recipient of the message.

33. Apparatus according to claim 31, wherein the processor is arranged to delete the attachment from the memory responsive to the command.

34. Apparatus according to claim 31, wherein the processor is arranged to actuate the data port to send the attachment to the recipient responsive to the command.

35. Apparatus according to claim 31, wherein the processor is arranged to change the transmission priority of the attachment responsive to the command.

36. Apparatus for processing electronic mail (e-mail), the apparatus comprising a mail server, the mail server comprising:
a data port arranged to be coupled to an electronic network; and
a processor, arranged to: (a) actuate the data port to receive an e-mail message having a first transmission priority, (b) subsequent to receiving the e-mail message, actuate the data port to receive an attachment to the e-mail message, the attachment having a second transmission priority, (c) identify a correspondence between the e-mail message and the attachment, and (d) download the e-mail message with the attachment to a designated recipient.

37. Apparatus for processing electronic mail (e-mail), the apparatus comprising a mail server, the mail server comprising:
a data port arranged to be coupled to an electronic network; and
a processor, arranged to: (a) actuate the data port to receive an e-mail message sent with a first transmission priority, and -to receive with the e-mail message an identifier of an attachment to the e-mail message, the attachment having a second transmission priority, (b) download the e-mail message to a designated recipient thereof, (c) transmit the identifier to the recipient, and (d) receive from the recipient a command with respect to the attachment.

38. Apparatus according to claim 37, wherein the processor is arranged to delete the attachment responsive to the command.

39. Apparatus according to claim 37, wherein the processor is arranged to change the transmission priority of the attachment responsive to the command.

40. Apparatus for processing a piece of electronic mail (e-mail), the apparatus comprising a server, the server comprising:
a data port arranged to be coupled to an electronic network; and
a processor, arranged to: (a) analyze addresses of a list of recipients of the e-mail, so as to determine two or more of the recipients who are served by a common e-mail server, (b) actuate the data port to send a single copy of the e-mail to the e-mail server, and (c) actuate the data port to send a command to the e-mail server directing the server to distribute the e-mail to the two or more recipients.

41. A computer program product for processing an electronic mail (e-mail) message having an attachment, the product comprising a computer-readable medium having program instructions embodied therein, which instructions, when read by a computer, cause the computer to:
receive as input from -a sender the e-mail message and the attachment, for transmission across a network to a recipient;
assign respective first and second priorities for transmission of the message and the attachment;
send the message to the recipient at the first priority; and
send the attachment to the recipient at the second priority.

42. A computer program product according to claim 41, wherein the instructions, when read by the computer, cause the computer to set the first priority to be higher than the second priority.

43. A computer program product according to claim 41, wherein the instructions, when read by the computer, cause the computer to receive a designation of at least one of the priorities from the sender.

44. A computer program product according to claim 41, wherein the instructions, when read by the computer, cause the computer to:
route the attachment to the recipient by way of an intermediate server; and
direct the intermediate server to wait for a command from the recipient, and to delete the attachment responsive to receiving a delete command from the recipient.

45. A computer program product according to claim 41, wherein the instructions, when read by the computer, cause the computer to:
route the attachment to the recipient by way of an intermediate server; and
direct the intermediate-server to wait for a command from the recipient, and to send the attachment to the recipient only after receiving the command.

46. A computer program product according to claim 45, wherein the instructions, when read by the computer, cause the computer to direct the intermediate server to change the second priority prior to sending the attachment.

47. A computer program product according to claim 41, wherein the instructions, when read by the computer, cause the computer to:
route the attachment to the recipient by way of an intermediate server; and
direct the intermediate server to send the attachment to the recipient at low priority.

48. A computer program product according to claim 47, wherein the instructions, when read by the computer, cause the computer to direct the intermediate server to store the attachment until a level of traffic on the network is below a threshold-'level.

49. A computer program product according to claim 41, wherein the instructions, when read by the computer, cause the computer to:
receive a command; and
interrupt transmission of the attachment, responsive to the command, so as to prevent receipt of the attachment by the recipient.

50. A computer program product according to claim 49, wherein the instructions, when read by the computer, cause the computer to receive the command from the recipient.

51. A computer program product according to claim 41, wherein the instructions, when read by the computer, cause the computer to couple respective identifiers to the message and the attachment, prior to sending the message and attachment, so as to enable a mail server receiving the message and attachment to identify a correspondence between the message and the attachment.

52. A computer program product according to claim 51, wherein the instructions, when read by the computer, cause the computer to couple respective Globally Unique ID's (GUID's) to the message and the attachment.

53. A computer program product for processing electronic mail (e-mail), the product comprising a computer-readable medium having program instructions embodied therein, which instructions, when read by a computer, cause the computer to:
receive, at an intermediate server, from a sending server, an attachment of an e-mail message, the message and; the attachment having different respective transmission priorities;
store the attachment;
receive a command from a designated recipient of the attachment; and
process the attachment responsive to the command.

54. A computer program product according to claim 53, wherein the instructions, when read by the computer, cause the computer to receive the command subsequent to a deletion by the recipient of the message.

55. A computer program product according to claim 53, wherein the instructions, when read by the computer, cause the computer to delete the attachment.

56. A computer program product according to claim 53, wherein the instructions, when read by the computer, cause the computer to send the attachment to the recipient.

57. A computer program product according to claim 53, wherein the instructions, when read by the computer, cause the computer to change the transmission priority of the attachment.

58. A computer program product for processing electronic mail (e-mail), the product comprising a computer-readable medium having program instructions embodied therein, which instructions, when read by a computer, cause the computer to:
receive over an electronic network an e-mail message having a first transmission priority;
subsequent to receiving the e-mail message, receive over the electronic network an attachment to the e-mail message, the attachment having a second transmission priority;
identify a correspondence between the e-mail message and the attachment; and
download the e-mail message with the attachment to a designated recipient.

59. A computer program product for processing electronic mail (e-mail), the product comprising a computer-readable medium having program instructions embodied therein, which instructions, when read by a computer, cause the computer to:
receive over an electronic network an e-mail message sent with a first transmission priority;
receive with the e-mail message an identifier of an attachment to the e-mail message, the attachment having a second transmission priority;
download the e-mail message to a designated recipient thereof;
transmit the identifier to the recipient; and
receive from the recipient a command with respect to the attachment.

60. A computer program product according to claim 59, wherein the instructions, when read by the computer, cause the computer to receive a command to delete the attachment.

61. A computer program product according to claim 59, wherein the instructions, when read by the computer, cause the computer to receive a command to change the transmission priority of the attachment.

62. A computer program product for processing a piece of electronic mail (e-mail), the product comprising a computer-readable medium having program instructions embodied therein, which instructions, when read by a computer, cause the computer to:
receive the e-mail;
analyze addresses of a list of recipients of the e-mail, so as to determine two or more of the recipients who are served by a common e-mail server;
send a single copy of the e-mail to the e-mail server; and
send an instruction to the e-mail server directing the server to distribute the e-mail to the two or more recipients.
